(19) United States
(12) Patent Application Publication
(10) Pub. No.: US 2024/0088415 A1
(43) Pub. Date: Mar. 14, 2024

(54) FUEL CELL SYSTEM AND CONTROL METHOD FOR FUEL CELL SYSTEM

(71) Applicant: HONDA MOTOR CO., LTD., Tokyo (JP)

(72) Inventors: Tomoyuki INOUE, WAKO-SHI (JP); Yuto NAKATANI, WAKO-SHI (JP)

(21) Appl. No.: 18/243,841

(22) Filed: Sep. 8, 2023

(30) Foreign Application Priority Data
Sep. 13, 2022 (JP) 2022-144968

(51) Int. Cl. H01M 8/04746; H01M 8/04119; H01M 8/04858

(52) U.S. Cl. CPC H01M 8/04753; H01M 8/04126; H01M 8/04776; H01M 8/0494

(57) ABSTRACT

A fuel cell system including an air discharge valve provided in an air discharge path, through which air discharged from a fuel cell stack flows, a bypass valve provided in a bypass path connecting an air supply path and the air discharge path and bypassing the fuel cell stack, and a controller for controlling the air discharge valve to make an opening degree of the air discharge valve smaller than full opening, controlling the bypass valve to make the opening degree of the bypass valve larger than fully closure, and controlling a compressor to supply air to the air supply path through which the air to be supplied to the fuel cell stack flows.

### CROSS-REFERENCE TO RELATED APPLICATIONS

This application is based upon and claims the benefit of priority from Japanese Patent Application No. 2022-144968 filed on Sep. 13, 2022, the contents of which are incorporated herein by reference.

### BACKGROUND OF THE INVENTION

### Field of the Invention

The present invention relates to a fuel cell system and a control method for the fuel cell system.

### Description of the Related Art

JP 2007-053015 A discloses a fuel cell system. While the fuel cell system is in operation, air is fed as an oxygen-containing gas from a compressor to a fuel cell stack via a humidity exchanger. An oxygen-containing off-gas from the fuel cell stack is discharged to the outside of the fuel cell system through a first exhaust pipe routed through the humidity exchanger. In the humidity exchanger, the oxygen-containing gas to be supplied to the fuel cell stack is humidified by the water contained in the humid oxygen-containing off-gas from the fuel cell stack.

While the fuel cell system is not in operation, the air is supplied from the compressor to the fuel cell stack to scavenge the fuel cell stack. The air that has passed through the fuel cell stack is discharged to the outside of the fuel cell system through a second exhaust pipe not routed through the humidity exchanger. Thus, water inside the fuel cell stack is removed.

### SUMMARY OF THE INVENTION

While the power generation by the fuel cell stack is being stopped, the amount of air supplied from the compressor is set to be relatively small in order to suppress noise, vibrations, and the like. If the compressor discharges a small amount of air, surges may occur in the compressor.

An object of the present invention is to solve the above-described problems.

According to a first aspect of the present invention, there is provided a fuel cell system for generating electrical power by chemical reactions caused in a fuel cell stack by supplying hydrogen as a fuel gas to an anode of the fuel cell stack and supplying air as an oxygen-containing gas to a cathode of the fuel cell stack, the fuel cell system including: an air supply path through which the air to be supplied to the fuel cell stack flows; an air discharge path through which the air discharged from the fuel cell stack flows; a drain path through which water discharged from the fuel cell stack flows; a bypass path connecting the air supply path to the air discharge path while bypassing the fuel cell stack; a bypass valve disposed on the bypass path and configured to adjust a flow rate of the air flowing through the bypass path; an air discharge valve disposed between the fuel cell stack and the bypass path on the air discharge path and configured to adjust a flow rate of the air flowing through the air discharge path; a compressor configured to supply the air to the air supply path; and a controller configured to control the compressor, the bypass valve and the air discharge valve, wherein in scavenging the fuel cell stack, the controller controls the air discharge valve to have an opening degree smaller than a fully opened state at a maximum, controls the bypass valve to have an opening degree greater than a fully closed state at a minimum, and controls the compressor to supply the air to the air supply path.

According to a second aspect of the present invention, there is provided a control method for a fuel cell system for generating electrical power by chemical reactions caused in a fuel cell stack by supplying a fuel gas to an anode of the fuel cell stack and supplying air to a cathode of the fuel cell stack, the fuel cell system including: an air supply path through which the air to be supplied to the fuel cell stack flows; an air discharge path through which the air discharged from the fuel cell stack flows; a drain path through which water discharged from the fuel cell stack flows; a bypass path connecting the air supply path to the air discharge path while bypassing the fuel cell stack; a bypass valve disposed on the bypass path and configured to adjust a flow rate of the air flowing through the bypass path; an air discharge valve disposed on the air discharge path between the fuel cell stack and the bypass path and configured to adjust a flow rate of the air flowing through the air discharge path; and a compressor configured to supply the air to the air supply path, the control method including, in scavenging the inside of the fuel cell stack, setting an opening degree of the air discharge valve to be smaller than a fully opened state at a maximum, setting an opening degree of the bypass valve to be greater than a fully closed state at a minimum, and supplying the air from the compressor to the air supply path.

According to the present invention, surges in the compressor can be suppressed during scavenging of the fuel cell system.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram of a fuel cell system;

FIG. 2 is a block diagram illustrating a configuration of a controller; and

FIG. 3 is a flowchart illustrating a scavenging control processing procedure executed in the controller.

### DETAILED DESCRIPTION OF THE INVENTION

### First Embodiment

### Configuration of Fuel Cell System

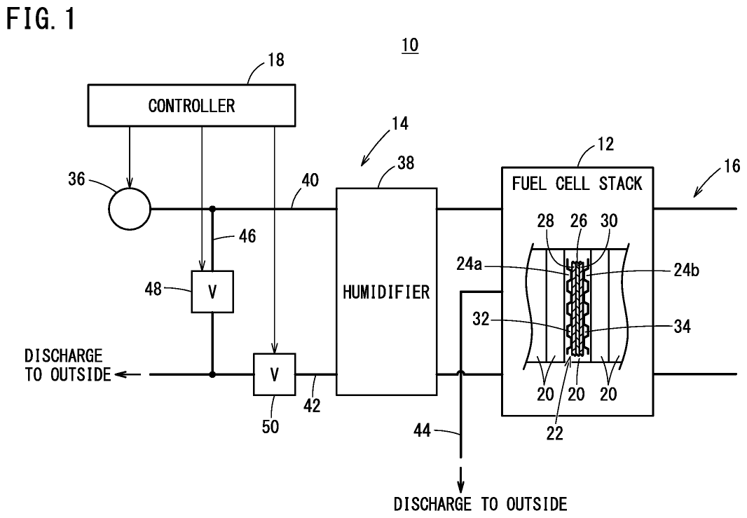

FIG. 1 is a schematic diagram of a fuel cell system 10. The fuel cell system 10 may be mounted in, for example, a fuel cell vehicle or the like.

The fuel cell system 10 includes a fuel cell stack 12, an oxygen-containing gas supply/discharge unit 14, a fuel gas supply/discharge unit 16, and a controller 18. In FIG. 1, the configuration of the fuel gas supply/discharge unit 16 is omitted.

The fuel cell stack 12 has a plurality of power generation cells 20 stacked one another. Each of the power generation cells 20 includes a membrane electrode assembly 22 and a pair of separators 24 (separators 24a and 24b). The membrane electrode assembly 22 is sandwiched between the pair of separators 24.

The membrane electrode assembly 22 includes an electrolyte membrane 26, a cathode 28, and an anode 30. The cathode 28 is provided on one surface of the electrolyte membrane 26. The anode 30 is provided on the other surface of the electrolyte membrane 26.

An oxygen-containing gas flow field 32 is formed on the separator 24a to allow the oxygen-containing gas to flow on one surface of the membrane electrode assembly 22. A fuel gas flow field 34 is formed on the separator 24b to allow the fuel gas to flow on the other surface of the membrane electrode assembly 22.

The oxygen-containing gas is supplied to the fuel cell stack 12 by the oxygen-containing gas supply/discharge unit 14. The oxygen-containing gas flows into the oxygen-containing gas flow field 32 of each of the power generation cells 20. The oxygen-containing gas is used for the chemical reactions at the cathodes 28. The unconsumed oxygen-containing gas (oxygen-containing off-gas) is discharged from the fuel cell stack 12 to the oxygen-containing gas supply/discharge unit 14.

The fuel gas is supplied to the fuel cell stack 12 by the fuel gas supply/discharge unit 16. The fuel gas flows into the fuel gas flow field 34 of each of the power generation cells 20. The fuel gas is used for the chemical reactions at the anodes 30. The unconsumed fuel gas (fuel off-gas) is discharged from the fuel cell stack 12 to the fuel gas supply/discharge unit 16.

The oxygen-containing gas supply/discharge unit 14 includes a compressor 36, a humidifier 38, an air supply path 40, an air discharge path 42, a drain path 44, and a bypass path 46.

The compressor 36 supplies air as the oxygen-containing gas to the air supply path 40. The oxygen-containing gas supplied to the air supply path 40 is humidified by the humidifier 38 and supplied to the fuel cell stack 12. The chemical reactions at the cathodes 28 produces water. The produced water flows from the fuel cell stack 12 to the drain path 44. The produced water having flowed into the drain path 44 is discharged to the outside of the fuel cell system 10. The oxygen-containing off-gas contains some of the produced water. The oxygen-containing off-gas flows from the fuel cell stack 12 to the air discharge path 42. The produced water contained in the oxygen-containing off-gas flowing into the air discharge path 42 is collected in the humidifier 38, and then the oxygen-containing off-gas is discharged to the outside of the fuel cell system 10.

In a state where the power generation by the fuel cell stack 12 is being stopped, scavenging is performed to remove water from the cathode 28 of each of the power generation cells 20. During scavenging, the compressor 36 supplies air to the air supply path 40. The air fed to the air supply path 40 is supplied to the fuel cell stack 12. The water in the cathode 28 of each of the power generation cells 20 flows from the fuel cell stack 12 to the drain path 44 together with the air supplied to the fuel cell stack 12. The water discharged to the drain path 44 is drained to the outside of the fuel cell system together with the air.

The bypass path 46 bypasses the fuel cell stack 12 and connects the air supply path 40 to the air discharge path 42. The bypass path 46 has a bypass valve 48. The bypass valve 48 adjusts the flow rate of the air flowing through the bypass path 46.

The humidifier 38 absorbs the water contained in the oxygen-containing off-gas discharged from the fuel cell stack 12 to the air discharge path 42, and humidifies the oxygen-containing gas from the air supply path 40 so that the oxygen-containing gas thus humidified is to be supplied to the fuel cell stack 12. The humidifier 38 is disposed between the bypass path 46 and the fuel cell stack 12 on both the air supply path and the air discharge path 42.

The air discharge path 42 has an air discharge valve 50. The air discharge valve 50 is disposed on the air discharge path 42 between the fuel cell stack 12 and the bypass path 46. The air discharge valve 50 is provided between the humidifier 38 and the bypass path 46 on the air discharge path 42. The air discharge valve 50 adjusts the flow rate of air in the air discharge path 42.

The controller 18 controls the compressor 36, the bypass valve 48, and the air discharge valve 50. The control by the controller 18 will be described in detail below.

### Configuration of Control Unit

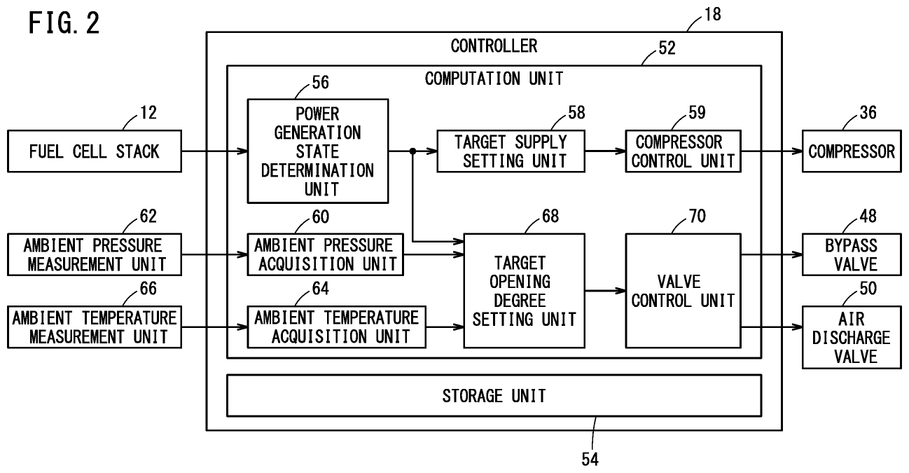

FIG. 2 is a block diagram illustrating a configuration of the controller 18. The controller 18 includes a computation unit 52 and a storage unit 54. The computation unit 52 is, for example, a processor such as a central processing unit (CPU) or a graphics processing unit (GPU). The computation unit 52 includes a power generation state determination unit 56, a target supply setting unit 58, a compressor control unit 59, an ambient pressure acquisition unit 60, an ambient temperature acquisition unit 64, a target opening degree setting unit 68, and a valve control unit 70. The power generation state determination unit 56, the target supply setting unit 58, the compressor control unit 59, the ambient pressure acquisition unit 60, the ambient temperature acquisition unit 64, the target opening degree setting unit 68, and the valve control unit 70 can be realized by the computation unit 52 executing programs which are stored in the storage unit 54. At least a part of the power generation state determination unit 56, the target supply setting unit 58, the compressor control unit 59, the ambient pressure acquisition unit 60, the ambient temperature acquisition unit 64, the target opening degree setting unit 68, and the valve control unit 70 may be realized by an integrated circuit such as an application specific integrated circuit (ASIC), a field-programmable gate array (FPGA) and the like. At least a part of the power generation state determination unit 56, the target supply setting unit 58, the compressor control unit 59, the ambient pressure acquisition unit 60, the ambient temperature acquisition unit 64, the target opening degree setting unit 68, and the valve control unit 70 may be realized by an electronic circuit including a discrete device.

The storage unit 54 may be made up of a volatile memory (not shown), and a non-volatile memory (not shown), as a computer-readable storage medium. Examples of the volatile memory include, for example, a RAM (Random Access Memory) or the like. As the non-volatile memory, there may be cited, for example, a ROM (Read Only Memory), a flash memory, or the like. Data, etc. may be stored in the volatile memory, for example. Programs, tables, maps, and the like are stored, for example, in the nonvolatile memory. At least a portion of the storage unit 54 may be provided in the processor, the integrated circuit, or the like, which were described above. At least a part of the storage unit 54 may be mounted on a device connected to the fuel cell system 10 via a network.

The power generation state determination unit 56 determines whether the fuel cell stack 12 is generating electrical power or is not generating electrical power.

The target supply setting unit 58 sets a target value of the volume of the oxygen-containing gas (air) supplied from the compressor 36 to the air supply path 40 per unit time. Hereinafter, the volume of the oxygen-containing gas (air) supplied from the compressor 36 to the air supply path 40 per unit time may be referred to as a supply amount. Further, the target value of the supply amount may be referred to as a target supply amount.

During scavenging, the target supply amount is set to a predetermined supply amount. In the case where the supply amount of the compressor 36 is equal to or less than the predetermined supply amount, the compressor 36 can be rotated at a relatively low speed. As a result, noise, vibrations, and the like caused by the compressor 36 are suppressed. As a result, for example, while the fuel cell vehicle is stopped, discomfort given to an occupant in the vehicle is reduced. The compressor control unit 59 controls the compressor 36 based on the target supply amount.

The ambient pressure acquisition unit 60 acquires the ambient pressure from the ambient pressure measurement unit 62. The ambient pressure measurement unit 62 is provided in, for example, the fuel cell vehicle or the like. The ambient pressure measurement unit 62 measures the ambient pressure outside the vehicle.

The ambient temperature acquisition unit 64 acquires the ambient temperature from the temperature measurement unit 66. The temperature measurement unit 66 is provided in, for example, the fuel cell vehicle or the like. The temperature measurement unit 66 measures the temperature of air outside the vehicle. The temperature measurement unit 66 may measure the temperature of the air at the air inlet of the compressor 36.

The target opening degree setting unit 68 sets a target opening degree of the bypass valve 48. The target opening degree of the bypass valve 48 during the scavenging is set based on the ambient pressure acquired by the ambient pressure acquisition unit 60 and the ambient temperature acquired by the ambient temperature acquisition unit 64. The target opening degree of the bypass valve 48 is set to be larger as the ambient pressure is higher. The target opening degree of the bypass valve 48 is set to be larger as the ambient temperature is lower. That is, the target opening degree of the bypass valve 48 is set to be larger as the density (mass per unit volume) of the air taken into the compressor 36 is larger.

The valve control unit 70 controls the air discharge valve 50 and the bypass valve 48. During scavenging, the valve control unit 70 controls the air discharge valve 50 to close. At the time of scavenging, the valve control unit 70 controls the bypass valve 48 to set the opening degree of the bypass valve 48 to the target opening degree set by the target opening degree setting unit 68. By adjusting the opening degree of the bypass valve 48, reduction in the amount of the air actually supplied from the compressor 36 is suppressed. Thus, surges in the compressor 36 can be suppressed.

### Scavenging Control Process

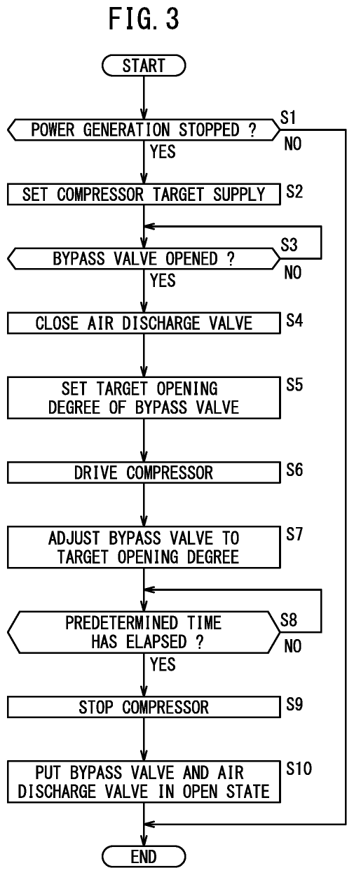

FIG. 3 is a flowchart illustrating a scavenging control processing procedure executed in the controller 18. The scavenging control process is executed once or a plurality of times after power generation by the fuel cell stack 12 is stopped.

In step S1, the power generation state determination unit 56 determines whether or not power generation has stopped in the fuel cell stack 12. When it is determined that the power generation is stopped in the fuel cell stack 12 (step S1: YES), the process transitions to step S2. When it is determined that the fuel cell stack 12 is in power generation operation (step S1: NO), the scavenging control process is brought to an end. When it is determined that the power generation is stopped in the fuel cell stack 12, the valve control unit 70 controls the bypass valve 48 to open the bypass valve 48.

In step S2, the target supply amount setting unit 58 sets the target supply amount of the compressor 36 to a predetermined supply amount. The process then transitions to step S3.

In step S3, the valve control unit 70 determines whether or not the bypass valve 48 is opened. When the bypass valve 48 is opened (step S3: YES), the process transitions to step S4. When the bypass valve 48 is not opened (step S3: NO), the determination of step S3 is repeated.

In step S4, the valve control unit 70 closes the air discharge valve 50. The process then transitions to step S5. The valve control unit 70 may fully close the air discharge valve 50 or set the opening degree of the air discharge valve 50 to be smaller than that in the fully-opened state.

In step S5, the target opening degree setting unit 68 sets the target opening degree of the bypass valve 48 based on the ambient pressure acquired by the ambient pressure acquisition unit 60 and the ambient temperature acquired by the ambient temperature acquisition unit 64. The process then transitions to step S6.

In step S6, the compressor control unit 59 drives the compressor 36 at the target supply amount set at step S2. The process then transitions to step S7.

In step S7, the valve control unit 70 opens the bypass valve 48 at the target opening degree set in step S5. The process then transitions to step S8.

In step S8, the compressor control unit 59 determines whether or not a predetermined time has elapsed from the start of driving the compressor 36. In the case where the predetermined time has elapsed (step S8: YES), the process transitions to step S9. In the case where the predetermined time has not elapsed (step S8: NO), the determination of step S8 is repeated. When the predetermined time has elapsed from the start of the driving of the compressor 36, it is determined that the scavenging inside the fuel cell stack 12 is completed.

In step S9, the compressor control unit 59 stops the compressor 36. The process then transitions to step S10.

In step S10, the valve control unit 70 puts the bypass valve 48 and the air discharge valve 50 in the open state. Thereafter, the scavenging control process is brought to an end. The valve control unit 70 may close the bypass valve 48 and the air discharge valve 50. The valve control unit 70 may open one of the bypass valve 48 and the air discharge valve 50 and close the other.

### Advantageous Effects

While power generation is stopped in the fuel cell stack 12, devices driven by electric power supplied from the fuel cell system 10 are often stopped. In a state where the other devices are stopped, noise and vibrations caused by the driving of the compressor 36 are likely to be felt by the user, and the user is likely to feel discomfort.

Therefore, during scavenging in which the power generation is stopped in the fuel cell stack 12, the target supply amount of the compressor 36 is set to a predetermined supply amount. In the case where the supply amount of the compressor 36 is equal to or less than the predetermined supply amount, the compressor 36 can be rotated at a relatively low speed. As a result, noise, vibrations, and the like caused by of the compressor 36 are suppressed. Thus, discomfort given to the user is suppressed.

On the other hand, in scavenging, since the amount of the air supplied from the compressor 36 is small, the volume of the air supplied to the fuel cell stack 12 is small, and the pressure in the oxygen-containing gas flow field 32 in each of the power generation cells 20 becomes low. As a result, there is a problem that it takes a long time to remove water from the cathodes 28.

Therefore, in the fuel cell system 10 of the present embodiment, in scavenging the fuel cell stack 12, the controller 18 controls the air discharge valve 50 to make the opening degree of the air discharge valve 50 smaller than the fully-opened state at a maximum. In this manner, because resistance in the air discharge path 42 increases, the pressure in the oxygen-containing gas flow field 32 in each of the power generation cells 20 can be made higher. As a result, the fuel cell system 10 can remove water from the cathode 28 in a short time.

When the pressure in the air supply path 40 increases as the pressure in the oxygen-containing gas flow field 32 in each of the power generation cells 20 increases, the amount of the air discharged from the compressor 36 decreases. In scavenging, because the target supply amount of the compressor 36 is set to be relatively small, if the amount of the air discharged from the compressor 36 decreases in this state, a surge is likely to occur in the compressor 36. Therefore, in the fuel cell system of the present embodiment, in scavenging the fuel cell stack 12, the controller 18 controls the bypass valve 48 to open at an opening degree larger than the fully-closed state at a minimum. As a result, the amount of air supplied to the fuel cell stack 12 is adjusted while the amount of air discharged from the compressor 36 is also adjusted to an amount with which a surge in the compressor 36 can be avoided. As a result, the fuel cell system 10 can suppress surges in the compressor 36.

In the fuel cell system 10 of the present embodiment, the air discharge valve 50 is provided between the bypass path 46 and the humidifier 38 on the air discharge path 42. If the air discharge valve 50 is opened in a state where the bypass valve 48 is closed, resistance in the air discharge path 42 decreases and the flow rate of the air in the air discharge path 42 can be increased. Therefore, by opening the air discharge valve 50, a decrease in the amount of air discharged from the compressor 36 is suppressed. However, since the humidifier 38 is provided in the air discharge path 42, there is a possibility that the resistance in the air discharge path 42 cannot be sufficiently reduced as desired even if the air discharge valve 50 is opened. In the fuel cell system 10 of the present embodiment, a decrease in the amount of air discharged from the compressor 36 is suppressed by adjusting the bypass valve 48 of the bypass path 46 instead of the air discharge valve 50 of the air discharge path 42 in which the humidifier 38 is provided. Thus, the fuel cell system 10 can suppress surges in the compressor 36.

In the fuel cell system 10 of the present embodiment, in scavenging the inside of the fuel cell stack 12, the controller 18 controls the air discharge valve 50 and the bypass valve 48 so that the flow rate of the oxygen-containing gas in the bypass path 46 is higher than the flow rate of the oxygen-containing gas in the air discharge path 42. Thus, the fuel cell system 10 can suppress surges in the compressor 36.

In the fuel cell system 10 of the present embodiment, in scavenging the inside of the fuel cell stack 12, the controller 18 controls the air discharge valve 50 to close. As a result, air is not discharged from the air discharge path 42, so that the pressure in the oxygen-containing gas flow field 32 in each of the power generation cells 20 can be increased. As a result, the fuel cell system 10 can remove water from the cathode 28 in a short time.

In the fuel cell system 10 of the present embodiment, in scavenging the inside of the fuel cell stack 12, the controller 18 sets the target opening degree of the bypass valve 48 based on the ambient pressure acquired by the ambient pressure acquisition unit 60 and the ambient temperature acquired by the ambient temperature acquisition unit 64. Thus, it is possible to prevent the mass of the air supplied to the fuel cell stack 12 from becoming excessive. Therefore, it is possible to prevent the pressure in the oxygen-containing gas flow field 32 in the fuel cell stack 12 from becoming excessively high. As a result, the fuel cell system 10 can suppress surges in the compressor 36.

Invention Obtained from Embodiments

The invention understood from the above embodiment will be described below.

The fuel cell system (10) for generating electrical power by chemical reactions caused in the fuel cell stack (12) by supplying hydrogen as the fuel gas to the anode (30) of the fuel cell stack (12) and supplying air as the oxygen-containing gas to the cathode (28) of the fuel cell stack. The fuel cell system includes: the air supply path (40) through which the air to be supplied to the fuel cell stack flows; the air discharge path (42) through which the air discharged from the fuel cell stack flows; a drain path (44) through which water discharged from the fuel cell stack flows; the bypass path (46) connecting the air supply path to the air discharge path while bypassing the fuel cell stack; the bypass valve (48) disposed on the bypass path and configured to adjust the flow rate of the air flowing through the bypass path; the air discharge valve (50) disposed between the fuel cell stack and the bypass path on the air discharge path and configured to adjust the flow rate of the air flowing through the air discharge path; the compressor (36) configured to supply the air to the air supply path; and the controller (18) configured to control the compressor, the bypass valve and the air discharge valve, wherein in scavenging the inside of the fuel cell stack, the controller controls the air discharge valve to have the opening degree smaller than the fully opened state at a maximum, controls the bypass valve to have the opening degree greater than the fully closed state at a minimum, and controls the compressor to supply the air to the air supply path. Thus, the fuel cell system can suppress surges in the compressor.

The above-described fuel cell system may further include a humidifier (38) provided between the bypass path and the fuel cell stack on the air supply path and the air discharge path and configured to humidify the air to be supplied to the fuel cell stack by the water contained in the air discharged from the fuel cell stack, and the air discharge valve may be disposed between the bypass path and the humidifier. Thus, the fuel cell system can suppress surges in the compressor.

In the above-described fuel cell system, in scavenging the inside of the fuel cell stack, the control unit may control the air discharge valve and the bypass valve to make the flow rate of the air in the bypass path higher than the flow rate of the air in the air discharge path. Thus, the fuel cell system can suppress surges in the compressor.

In the above-described fuel cell system, in scavenging the inside of the fuel cell stack, the control unit may control the air discharge valve to close. As a result, the fuel cell system can remove water from the cathode in a short time.

The above-described fuel cell system may further include the ambient pressure acquisition unit (60) configured to acquire the ambient pressure, and the ambient temperature acquisition unit (64) configured to acquire the temperature of the air taken into the compressor. In scavenging the fuel cell stack, the control unit may set the opening degree of the bypass valve based on the ambient pressure and the temperature of the air. Thus, the fuel cell system can suppress surges in the compressor.

In the control method for the fuel cell system for generating electrical power by chemical reactions caused in a fuel cell stack by supplying the fuel gas to an anode of the fuel cell stack and supplying air to the cathode of the fuel cell stack, the fuel cell system including: the air supply path through which the air to be supplied to the fuel cell stack flows; the air discharge path through which the air discharged from the fuel cell stack flows; a drain path through which water discharged from the fuel cell stack flows; the bypass path connecting the air supply path to the air discharge path while bypassing the fuel cell stack; the bypass valve disposed on the bypass path and configured to adjust the flow rate of the air flowing through the bypass path; the air discharge valve disposed between the fuel cell stack and the bypass path on the air discharge path and configured to adjust the flow rate of the air flowing through the air discharge path; and the compressor configured to supply the air to the air supply path. The control method includes, in scavenging the inside of the fuel cell stack, setting the opening degree of the air discharge valve to be smaller than a fully opened state at a maximum, setting the opening degree of the bypass valve to be greater than the fully closed state at a minimum, and supplying the air from the compressor to the air supply path. Thus, the fuel cell system can suppress surges in the compressor.

Moreover, the present invention is not limited to the above-described disclosure, and various configurations can be adopted therein without departing from the essence and gist of the present invention.

1. A fuel cell system for generating electrical power by chemical reactions caused in a fuel cell stack by supplying hydrogen as a fuel gas to the anode of a fuel cell stack and supplying air as an oxygen-containing gas to the cathode of the fuel cell stack, the fuel cell system comprising:
an air supply path through which the air to be supplied to the fuel cell stack flows;
an air discharge path through which the air discharged from the fuel cell stack flows;
a drain path through which water discharged from the fuel cell stack flows;
a bypass path connecting the air supply path to the air discharge path while bypassing the fuel cell stack;
a bypass valve disposed on the bypass path and configured to adjust the flow rate of the air flowing through the bypass path;
an air discharge valve disposed between the fuel cell stack and the bypass path on the air discharge path and configured to adjust a flow rate of the air flowing through the air discharge path;
a compressor configured to supply the air to the air supply path; and
one or more processors that execute computer-executable instructions stored in a memory, wherein the one or more processors execute the computer-executable instructions to cause the fuel cell system to control the compressor, the bypass valve and the air discharge valve, wherein
in scavenging an inside of the fuel cell stack, the one or more processors cause the fuel cell system to:
control the air discharge valve to have an opening degree smaller than a fully-opened state at a maximum,
control the bypass valve to have an opening degree greater than a fully-closed state at a minimum, and
control the compressor to supply the air to the air supply path.

2. The fuel cell system according to claim 1, further comprising:
a humidifier provided between the bypass path and the fuel cell stack on the air supply path and on the air discharge path, and configured to humidify the air to be supplied to the fuel cell stack by the water contained in the air discharged from the fuel cell stack, wherein
the air discharge valve is disposed between the bypass path and the humidifier.

3. The fuel cell system according to claim 1, wherein
in scavenging the inside of the fuel cell stack, the one or more processors cause the fuel cell system to:
control the air discharge valve and the bypass valve to make a flow rate of the air in the bypass path higher than a flow rate of the air in the air discharge path.

4. The fuel cell system according to claim 1, wherein in scavenging the inside of the fuel cell stack, the one or more processors cause the fuel cell system to:
control the air discharge valve to close.

5. The fuel cell system according to claim 1, wherein the one or more processors cause the fuel cell system to:
acquire an ambient pressure;
acquire a temperature of the air to be taken into the compressor; and
in scavenging the inside of the fuel cell stack, set an opening degree of the bypass valve based on the ambient pressure and the temperature of the air.

6. A control method for a fuel cell system for generating electrical power by chemical reactions caused in a fuel cell stack by supplying a fuel gas to an anode of a fuel cell stack and supplying air to a cathode of the fuel cell stack,
the fuel cell system comprising:
an air supply path through which the air to be supplied to the fuel cell stack flows;
an air discharge path through which the air discharged from the fuel cell stack flows;
a drain path through which water discharged from the fuel cell stack flows;
a bypass path connecting the air supply path to the air discharge path while bypassing the fuel cell stack;
a bypass valve disposed on the bypass path and configured to adjust a flow rate of the air flowing through the bypass path;
an air discharge valve disposed between the fuel cell stack and the bypass path on the air discharge path and configured to adjust the flow rate of the air flowing through the air discharge path; and
a compressor configured to supply the air to the air supply path;
the control method comprising in scavenging an inside of the fuel cell stack:
setting an opening degree of the air discharge valve to be smaller than a fully opened state at a maximum,
setting an opening degree of the bypass valve to be greater than the fully closed state at a minimum, and
supplying the air from the compressor to the air supply path.
